(19) United States
(12) Patent Application Publication
(10) Pub. No.: US 2009/0042545 A1
(43) Pub. Date: Feb. 12, 2009

(54) SYSTEM AND A METHOD FOR UNIFYING THE SOCIAL REALITIES OF THE ONLINE INTERNET AND REAL WORLD OF THE MOBILE PHONE

(76) Inventors: Tamir Avital, Tel Aviv (IL); Yosef Asaf Zagury, Tel Aviv (IL)

Correspondence Address: Naomi Assia Law Offices;C/O Landon IP Inc., Suite 450, 1700 Diagonal Road, Alexandria, VA, 22314, US

(21) Appl. No.: 11/834,031

(22) Filed: Aug. 6, 2007

(51) Int. Cl. H04M 3/42

(52) U.S. Cl. 455/414.1

(57) ABSTRACT

A method combining mobile phone and Internet technologies to create one unified reality. The method includes creating personal Webpage content on a Website. The content may include personal information, pictures, videos and a blog. The method also includes adding details of other people in one's proximity, as recognized by one's mobile phone, to a newbie page, allowing one to initiate an online interaction and later to classify the people into categories and showing the personal information to the other people filtered by the categories, such that the personal Webpage content interacts with mobile phone proximity recognition to initiate valuable longer term relationships.

### FIELD OF THE INVENTION

The present invention relates generally to the Internet and the Mobile Phone, and more particularly, the invention relates to a system and a method for interaction between the social aspects of the online Internet and real world of the mobile phone.

### BACKGROUND OF THE INVENTION

Nowadays we're experiencing a Social Technology revolution that changes our life. This revolution is being lead by two personal technologies The Internet and the Mobile Phone, each representing a different social reality The Real (Mobile) and The Online (Internet). To this day, there is no innovation which meshes between these into one unified reality.

In 2007, almost every third person has a mobile phone, and the Internet is in almost every home in the Western world. Those two technologies have changed the rules of personal and group social interactions.

The mobile phone has positioned itself as a leading medium, and changes almost every aspect of our lives: entertainment, commerce and leisure, by allowing us to be available for any kind of communication. The mobile phone is with us all day, every day, all the time. We can no longer relate to the cell phone as a technology only, rather it is a cultural phenomenon rapidly changing and redefining our work, our leisure and us as consumers.

The Internet was first established as a technology strictly for exchanging information, but during the last several years, the Internet has created an alternate reality—an online reality. This new online reality allows each of us to share his life with others by using photos, videos, blogs, files, etc. This new phenomenon is referred to as Social Networking.

Both of these phenomena have brought a revolution in advertising. While the expenses on traditional advertising constantly fall, the growth of targeted and direct digital advertising is rising. The social technology causing the tremendous rise in digital advertising has yet to be genuinely implemented on the mobile platform.

The Internet and mobile phone have created a new foundation for forming new social bindings and relationships. Those two mega phenomena open the door to a whole world of new business opportunities and the financial potential concealed in them has yet to be fully understood.

A question comes to mind. Why not combine all these trends, why not enjoy all those worlds? Why not unify physical reality with online reality?

Many people live in two separate realties. Living their life, the mobile phone is used mainly for communication with friends, family and co-workers. At home people have created a separate online reality using the Internet, by publishing personal information about themselves in order to create new friends with similar fields of interest, or using online dating sites to find love. Despite the great personal exposure, only in rare cases do online friends actually meet in real life. Interaction between the Web and the real world tends to be frightening, and only a small portion of the online friendships become real life friendships. The other way around, everyday interactions with people that you meet in the supermarket, the bank or the coffee shop, are usually very short.

Thus, it would be desirable to develop short interesting interactions into opportunities to create a new friend, a new business partner or even meet the love of your life.

### SUMMARY OF THE INVENTION

Accordingly, it is a principal object of the present invention to provide an integrated platform based on the mobile phone and the Internet technologies in order to create one unified social reality.

It is another principal object of the present invention to use the mobile phone to automatically transfer details of other people you meet in your daily life into the Web, simply by carrying one's mobile phone.

It is one other principal object of the present invention to use new opportunities created by short term accidental interactions for creating new friends with similar fields of interests, new business partners or even your next love.

A method is disclosed combining mobile phone and Internet technologies to create one unified reality. The method includes personal Webpage content on a Website. The content may include personal information, pictures, videos and a Weblog. The method also includes adding details of other people in one's proximity, as recognized by one's mobile phone, to a newbie page, allowing one to initiate an online interaction and later to classify the people into categories and showing the personal information to the other people filtered by the categories, such that the personal Webpage content interacts with mobile phone proximity recognition to initiate valuable longer term relationships.

The platform created on the Web will allow a second look at the mobile phone carrying people one meets, and/or are in proximity to, during the day and allow one to find out more about them and facilitate initiation of online interaction. The mobile phone will “remember” the people you came across during the day, automatically send their ID to the server connected to the Internet, for example by Bluetooth technology. The platform enables one to create a social history of one's interactions, without any manual activity required, besides building the profile of people one is looking for. The online platform will include a Webpage with personal information, pictures, videos and a blog. People you've been around will be added to a newbie page, allowing you to initiate an online interaction and later to classify them into categories like: cute girls, business associates, surfing pals, etc. The personal information shown to other people will be filtered by the categories to which the viewer is classified. 3^{rd} party interactions could also be created, for example people from other countries you've visited could become the next local guide for your friend visiting there.

The application will allow creating an immediate mobile interaction with people in close proximity. The user will be able to scroll the people around him on the mobile, press on the other person's picture and send him a text/multimedia message. These kinds of interactions will be sent to the Website as well.

Utilizing all user information will enable creation of highly targeted advertising on the mobile platform, as well as on the online platform. The application will present targeted ads only if the user clicked on the link on the mobile phone. Prior art mobile advertising is generally based on SMS, which most people consider being spam and tend to delete the SMS immediately.

By contrast, the advertising on the Web platform of the present invention, although similar to other social Websites, utilizes a unique user profile and stored navigation habit, in order to more precisely target the advertising. The effective mobile advertising will be based on the social habit of “digging” into the mobile phone in everyday routine usage, for example, when one is trying to “kill” time, in situations such as waiting at the dentist, in line at the bank, riding on a bus or waiting for a meeting to start.

Unlike other advertising trying to catch the eye of the beholder, while watching TV, driving the highway or searching the Web, with the present invention the user is looking for a highly personalized advertisement in order to avoid a less interesting activity! Such advertising is plainer, more focused and thus more highly effective, since the person is very attentive and his “guard” is down. These ads can initiate immediate consumption, such as a 10% discount at Nike stores, a sale at Zara or free coupons at the coffee shop.

As advertising becomes more targeted, and therefore more efficient, a small business, such as the local shoe store, can reach its target market with a tailored, low-cost budget. Large companies can enhance their ad campaigns by designing video streaming commercials, using 3G bandwidth, suited to the mobile phone platform and geared to the more attentive “mode” of the user, thereby increasing the exposure of the brand.

Creation of a unified reality social allows anyone to enjoy a wider range of friends, over larger geographical regions simply by carrying his mobile phone. Cellular vendors which will provide a free application in order to increase their market share.

Since the most powerful force on the cellular industry is the mobile operators, they have the strongest incentive to increase their revenues by providing more content to the users. The operators are looking for new innovative ways to increase their ARPU since the predicted figures show a fall in their income growth.

The mobile operators have not had a “killer application” since the SMS. The mobile social platform will open the gate for a whole new range of revenues, not only from monthly fees, but from targeted based advertising on the mobile phone and bring a real growth in their incomes.

In some markets, providers not only sell cellular services but sell most of the mobile phones, therefore, their advertising power and expenses are even higher. By cooperating with the mobile operators and their strong incentives, the penetration rate should be much faster. Furthermore, the willingness of the end-user to pay through his cellular bill (unlike paying through the Internet) is high. The value for less productive content, such as ring-tones and wallpapers, is already being paid, and the end-user will have a willingness to pay for the social service.

The marketing strategy will be based on:
1. Using the mobile operators as a strategic partner with high financial abilities.
2. Using advertising to emphasize the dating possibilities, for which the client's willingness to pay is much higher (In contrast to the other social services which are being offered for free).
3. Promotion in universities and colleges, and using the 20+ population as influence leaders.
4. Promotion in public places like restaurants, coffee shop networks and pubs through the cellular providers.

The deployment process will be as follows:
1. Developing a prototype on the 3-4 most popular mobile phones, an online basic platform in order to raise more funds and to find a strategic partner (probably a cellular provider).
2. Expanding the application to the necessary minimum in order to provide the service to users: mobile application, Website, billing server.
3. Expanding the application to target advertising, more languages, importing existing social networking profiles, marketing paid researches using polls etc.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in which:

FIG. 1 is a schematic block diagram of the general system architecture of the present invention, constructed in accordance with the principles of the present invention;

FIG. 2 is a flow chart of the automatic operations, performed in accordance with the principles of the present invention;

FIG. 3 is a flow chart of the alternative automatic operations, performed in accordance with the principles of the present invention;

FIG. 4 is a flow chart of the manual operations, performed in accordance with the principles of the present invention; and

FIG. 5 is a flow chart of the advertising process, performed in accordance with the principles of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

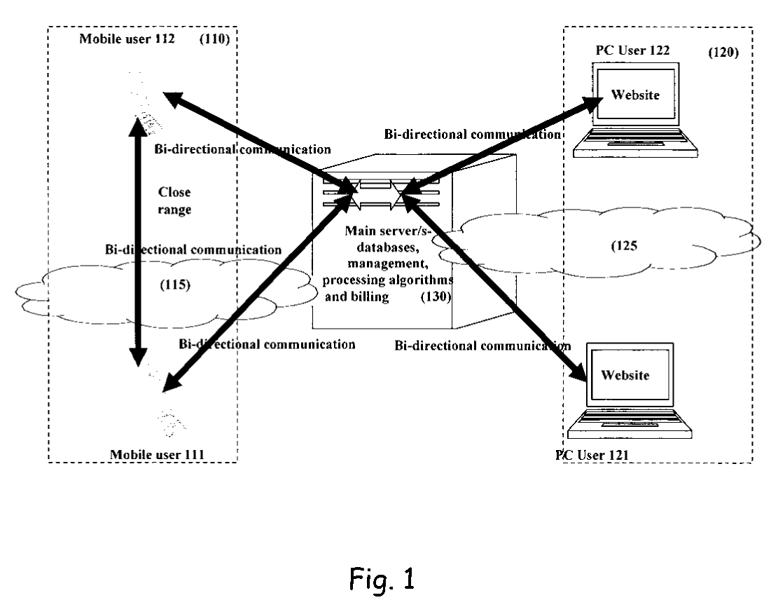

FIG. 1 is a schematic block diagram of the general system architecture of the present invention, constructed in accordance with the principles of the present invention.

The application consists of two parts, a mobile application 110 and the Website 120. Physically, the Internet 125 uses a portion of the total resources of the currently existing public telecommunication networks 115. Technically, what distinguishes Internet 125 is its use of a set of protocols called TCP/IP (for Transmission Control Protocol/Internet Protocol). The most widely used part of Internet 125 is the World Wide Web (WWW). Its outstanding feature is hypertext, a method of instant cross-referencing. In most Web sites, certain words or phrases appear in text of a different color than the rest; often this text is also underlined. When one selects one of these words or phrases, there is a transfer to the site or page that is relevant to this word or phrase. Sometimes there are buttons, images, or portions of images that are “clickable.” If one moves the pointer over a spot on a Web site and the pointer changes into a hand, this indicates that you can click and be transferred to another site.

A cellular network is a radio network made up of a number of radio cells (or just cells) each served by a fixed transmitter, known as a cell site or base station. These cells are used to cover different areas in order to provide radio coverage over a wider area than the area of one cell. Cellular networks are inherently asymmetric with a set of fixed main transceivers, each serving a cell and generally a set of distributed mobile transceivers, which provide services to the network's users.

Public Switched Telephone Network (PSTN) 115 is the traditional landline network that mobile wireless systems connect with to complete calls. In relation to Internet 125, PSTN 115 actually furnishes much of the Internet's long-distance infrastructure. Internet service providers (ISP's) pay the long-distance providers for access to their infrastructure and share the circuits among many users.

The mobile application has two different uses, manual and automatic. In a first automatic application, when two people, mobile user 111 and mobile user 112, are in proximity and each conforms to the other's white-list criteria, user details for each, together with any interaction that may have occurred, are sent to the Website for PC user 121 and PC user 122 by the main server/s-databases 130, which are also responsible for management, processing algorithms and billing.

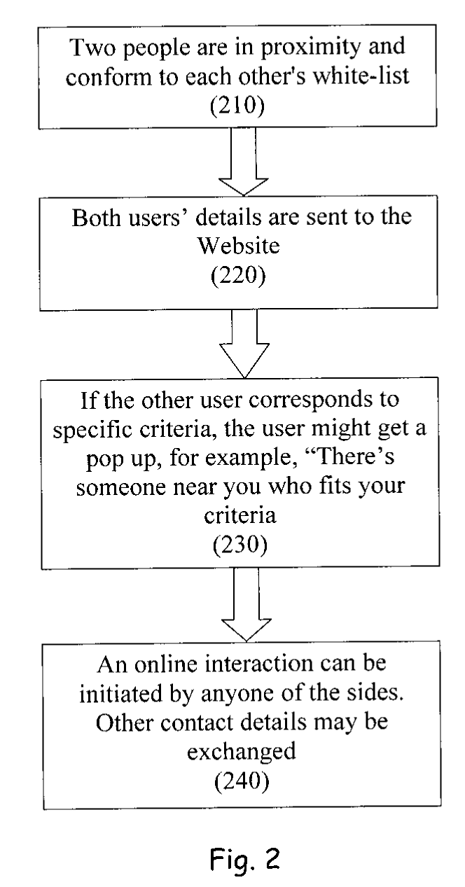

FIG. 2 is a flow chart of the automatic operations of FIG. 1, performed in accordance with the principles of the present invention. Two people in proximity each conform to the other's white-list criteria 210. User details for each will be sent to the PC by the Website 220. If the second user corresponds to specific criteria the first user, the first might get a pop up, for example, “There's someone near you who fits your criteria” 230. Users pre-define criteria for which they want a real-time alert. Users not conforming to each other's criteria can also be shown, but in a different tab on the Website.

A user may see someone with which he would like to initiate a conversation. The user opens the application and scrolls through the pictures of other users. Users who do not conform to each other white-list criteria will not appear on the list of pictures. It may be the other person just does not have the application, with Bluetooth™ for example, rather than does not conform to the other user's criteria.

If a user does not have the application, the other user can send him a link inviting him to download the application.

Online interaction can be initiated with people one has been around 240.

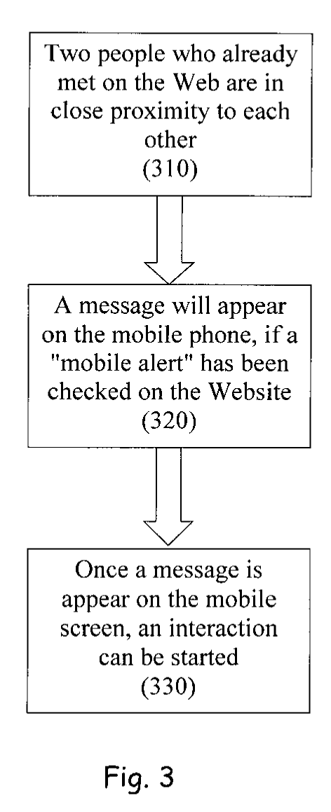

FIG. 3 is a flow chart of the alternative automatic operations, performed in accordance with the principles of the present invention. Two people, who already met on the Web, are in proximity to each other 310. A message will appear on the mobile phone, if a “mobile alert” has been checked on the Website 320. Once a message appears on the mobile screen, an interaction can be started 330.

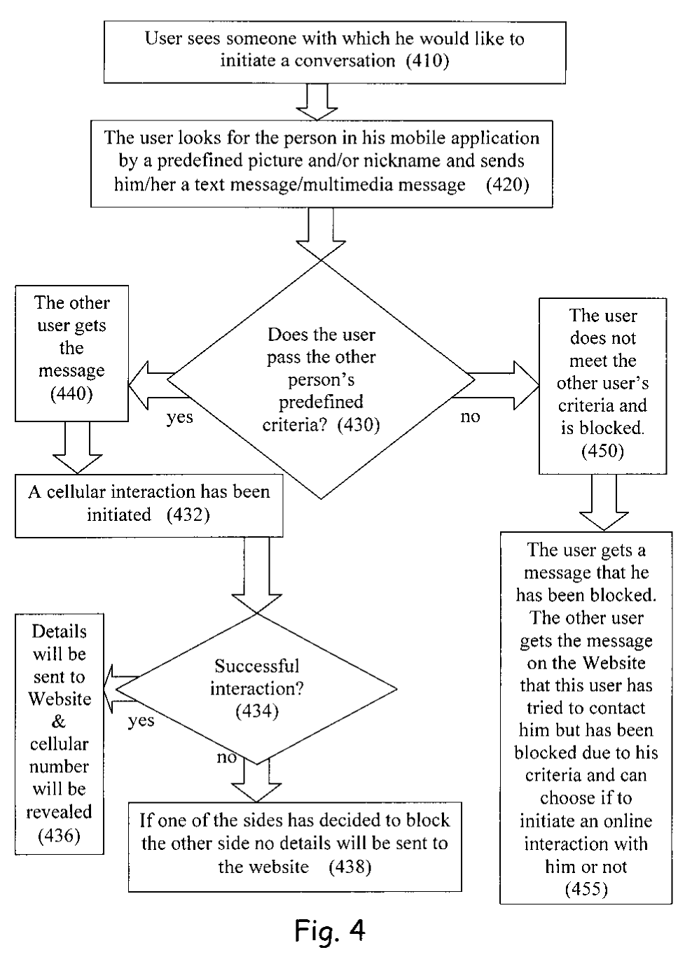

FIG. 4 is a flow chart of the manual operations, performed in accordance with the principles of the present invention. A user sees someone with which he would like to initiate a conversation 410. The user opens the application and scrolls through the pictures of other users. Once the other user has been selected, the user is able to begin an interaction with him. He could send a text message, a multimedia message, different kinds of templates, or a wink, smile or love arrow 420. A user can only see other users who answer his user's “white-list” criteria 430. If he corresponds to the criteria 430 the other person gets the message 440 and chooses whether to answer it or not. If not blocked a cellular interaction is initiated 432. If the interaction is successful 434 details will be sent to Website and the cellular number will be revealed 436. If one of the sides has decided to block the other side no details will be sent to the Website 438.

If the user does not meet the other user's criteria he is blocked 450. The user gets a message that he has been blocked. The other user gets the message on the Website that this user has tried to contact him, but has been blocked due to his criteria, and can choose if to initiate an online interaction with him or not 455.

All the automatic and manual mobile and online interactions of a user are arranged on a timeline, thus, creating a social history of the user.

Optionally, a search can be made by all the times/dates the user has been around a particular person or by places the user has been.

Mobile access to the Website is possible and enables full functionality.

The Website can be used for several applications:
1. Two persons who have already engaged in conversation using the mobile application will be added to each other's personal Webpage.
2. People who have been in each other's proximity will be added to the Website to initiate a later online interaction.
3. People could initiate conversations based on communities.
4. Interaction with 2nd/3rd (etc) party friends could be initiated as well, while browsing your friends' profiles.
5. Browsing through one's social history by time and date, places and other people one has known.
6. Updates on interactions initiated on the Website could be sent to the mobile phone.
7. Interactions could also be continued on the mobile phone.

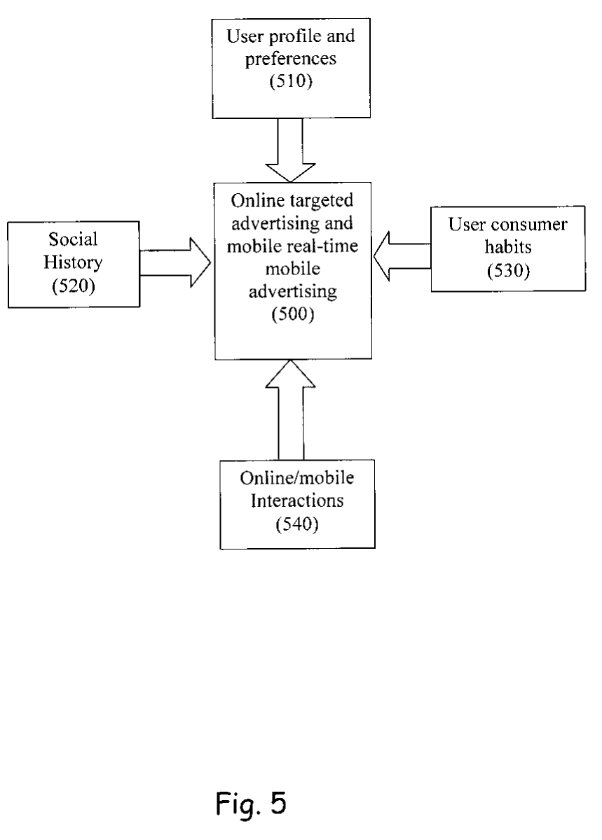

FIG. 5 is a flow chart of the targeted advertising process, performed in accordance with the principles of the present invention. Online targeted advertising 500 is based on user profiles 510, preferences, consumer habits 530 (by clicking other advertisements) mobile and online interactions 540 and analysis of social history 520. Mobile real-time targeted advertising, such as relevant restaurants, clothes, sales, etc., based on user profile, preferences, consumer habits 530 (by clicking other advertisements) mobile and online interactions 540 and analysis of social history 520.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method combining a mobile phone application and Internet technologies to create one unified social reality for a plurality of users, said method comprising:
adding an application to a mobile phone of each of said plurality of users;
creating personal Webpage content for each of said plurality of users on a Website comprising at least one of personal information, pictures, videos and a blog;
adding details of other people in one's proximity, as recognized by each of said plurality of users' mobile phones, to a newbie page, allowing each of said plurality of users to initiate an online interaction and later to classify said people into categories; and
showing said personal information to said other people filtered by said categories and by criteria for interaction established by each of said plurality of users,
such that the personal Webpage content interacts with mobile phone proximity recognition to initiate valuable longer term relationships.

2. The method of claim 1, further comprising automatically transferring by one's mobile phone into said Website of said details of other people in one's proximity, comprising at least the time, date and location of said being in one's proximity.

3. The method of claim 1, wherein said valuable longer term relationships comprise at least one of creating new friends with similar fields of interests, new business partners and one's next love.

4. The method of claim 1, further comprising remembering said other people by one's mobile phone, thereby enabling one to create a social history of one's daily interactions.

5. The method of claim 1, further comprising filtering said personal information shown to said other people by said categories.

6. The method of claim 1, further comprising creating second and third party interactions.

7. The method of claim 1, further comprising scrolling the images on one's mobile of one of said other people in one's proximity.

8. The method of claim 7, further comprising pressing on one of said images and sending said other person a text message.

9. The method of claim 8, further comprising pressing on one of said images and sending said other person a multimedia message.

10. The method of claim 8, further comprising sending said interaction to the Website.

11. The method of claim 1, further comprising utilizing all said user information to enable creation of highly targeted advertising on said online platform

12. The method of claim 1, further comprising utilizing all said user information to enable creation of advertising on the mobile phone.

13. The method of claim 12, wherein said advertising is location based advertising.

14. The method of claim 1, wherein users not conforming to each other's said criteria are shown in a different tab on the Website.

15. The method of claim 11, wherein said advertising is targeted according to online usage patterns of each of said plurality of users.

16. The method of claim 12, wherein said advertising is targeted according to mobile phone usage patterns of each of said plurality of users.

17. The method of claim 1, wherein said creating step is done automatically, and wherein said automatically created content can be redefined by said user.

18. The method of claim 1, wherein said creating step is done manually.

19. The method of claim 1, further comprising receiving an alert on said mobile phone of a first of said plurality of users, if a second of said plurality of users is in the proximity of said first user which conforms to said first user's criteria, and said first user has indicated a desire to receive mobile proximity alerts.

20. The method of claim 1, further comprising receiving an alert by a first of said plurality of users on his mobile phone, if a second of said plurality of users is in the proximity of said first user, wherein said first user and said second user have previously met on the Web.

21. A system combining technologies relative to the mobile phones and the Internet browsers of a plurality of users to create one unified social reality, said system comprising:
a Website wherein personal Webpage content for said plurality of users, said content comprising at least one of personal information, pictures, videos and a blog; and
at least one main server and at least one database for sending user details and the time, date and location extracted from said content to said Website for said plurality of users,
such that said personal Webpage content interacts with mobile phone proximity recognition to initiate valuable longer term relationships between pairs of said plurality of users.

22. The system of claim 21, wherein said Website is also responsible for management, processing algorithms and billing.
